(19) United States
(12) Patent Application Publication
(10) Pub. No.: US 2009/0039162 A1
(43) Pub. Date: Feb. 12, 2009

(54) Tag reader and the tag

(76) Inventor: Leeway Yen, Hsinchu County (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/907,969

(22) Filed: Oct. 19, 2007

(30) Foreign Application Priority Data
Aug. 10, 2007 (TW) 096213258

(51) Int. Cl. G06K 7/10

(52) U.S. Cl. 235/462.11; 235/462.07; 235/462.18; 235/462.25; 235/462.32; 235/492

(57) ABSTRACT

A tag reader and the tag are disclosed. The tag comprises a barcode pattern layer and horizontal line segments, which are connected to form an RF antenna. The antenna is further electrically connected to an RF chip, wherein an RF chip data is recorded in the RF chip. The tag reader comprises an RF signal transmitter for transmitting an RF transmitting signal to detect a tag. When an RF reflecting signal has been received, a light source module is enabled to shoot a scanning light source for scanning the tag; therefore, a tag comparing signal can be obtained. Thus, the advantages of the barcode and RFID tag can be integrated, the application field of the tag will be broadened, and the reliability of tag data reading is enhanced due to the double check mechanism.

### FIELD OF THE INVENTION

The present invention relates to a tag reader and the tag, more particularly to a tag being readable for both the barcode reader and the Radio Frequency Identification (RFID) reader, and a tag reader used for which.

### BACKGROUND OF THE INVENTION

Due to international trade is getting more and more flourishing, the trade control plays a very important role, the merchandise trading transaction especially, wherein a tag applied on the merchandise is easily for reading by the reading machine that can be used to control the merchandise information during the merchandise trading transaction.

The prior art method for reading the tag includes two types, one of which is the optical barcode scan, the other is RFID tag read. Referring to FIG. 1A, there shows a diagram of the prior art regarding to the barcode reader is used to read the barcode. Usually, merchandise 19 will be attached a barcode 15 thereon, such as a 1D barcode or an EAN.UCC barcode shown on the figure. The barcode 15 consists of vertical lines 155. The barcode reader 11 can shoot a scanning light from a light source module 115 thereof, and the scanning light 115 will be reflected by the barcode 15, and further, the reflected scanning light will be latched by an image sensor 117 and a micro processor 113, therefore, the corresponding pattern image according to the vertical lines of the barcode will be decoded, accordingly, the merchandise information will be obtained due to the barcode has been read.

The barcode reading system is with the advantages of low-cost, long life-time, and long application history, such that the market shares of which is higher than others.

Referring to FIG. 1B, there shows a diagram of the prior art regarding to the RFID tag reader is used to read the RFID tag. The RFID tag 17 comprises an RF antenna 171 electrically connected to an RF chip 173, wherein the RF antenna 171 is used to receive the RFID signal, and the RF chip 173 is used to store a great quantity of merchandise information. Therefore, a user can utilize an RF transmitter 135 of an RF reader 13 to transmit an RF signal constantly, thereafter, the RF signal will be received by the RF antenna 171, and further, the merchandise information stored within the RF chip 173 will be read and transmitted to an RF signal receiver 137 and a micro processor 133, such that the merchandise information stored within the RFID tag 17 will be obtained according to the RFID signal.

The RFID tag system has the advantages of being used in adverse circumstance, storing a great quantity of merchandise information, and obtaining various merchandise information rapidly, therefore, the RFID tag will be the mainstream in the near future of the market according to the expectation of most consumers and manufacturers.

However, the optical barcode 15 has to be read by the barcode reader 11, and the RFID tag 17 has to be read by the RFID reader 13. These two types of reading tags cannot be applied in the same machine, that is, the barcode reader 11 cannot be used to read the merchandise information stored within the RFID tag 17, as well as, the RFID reader 13 cannot be used to read the information shown as the optical barcode 15. Thus, to use two incompatible reading tag systems is troublesome for consumers, traders, and manufacturers.

Furthermore, the light source module 115 of the barcode reader 11 has to shoot a scanning light constantly; otherwise, the user has to manually switch the scanning light, therefore, this type of reading tag is inconvenient and further that will increase the power consumption. Transparently, both the barcode reader 11 and the RF reader 13 can only read one type of tag signal, thus, the reliability of the merchandise information reading will be limited due to the lack of the double checking.

### SUMMARY OF THE INVENTION

A novel tag reader and the tag are disclosed according to the foregoing mentioned shortcomings of prior art tag reading system. The tag reader can be used to read two types of tags including the optical barcode and the RFID tag, such that the advantages of both can be obtained. Further, the application field of the present invention can be broadened, and the application thereof is more convenient for people, certainly, the read merchandise information is more reliable.

It is a primary object of the present invention to provide a tag reader, which can be used to read both the optical barcode and the RFID tag and proceed the double checking, such that the read merchandise information can be more reliable and the application field of the tag reader can be broadened, such as the application in an entrance guard system.

It is a secondary object of the present invention to provide a tag reader, comprising a light source module, which can be enabled after receiving an RF reflecting signal by the RF signal transmitter, thereafter, the light source module will be disabled after a period of time, thus, the power consumption can be reduced accordingly, and the life-time thereof can be extended.

It is another object of the present invention to provide a tag being readable for two types of tag readers, including the barcode reader and RFID reader, which can combined the advantages of both, therefore, the tag is convenient for reading by the barcode reader and the RFID reader, accordingly, the application field of the tag can be broadened, and the application thereof is more convenient for people.

It is another object of the present invention to provide a tag being readable for the barcode reader and the RFID reader, such that the pressure of time and the purchasing cost can be reduced during the transition while the application of the barcode reader is going to be transferred to the application of the RFID reader.

It is another object of the present invention to provide a tag, which can prevent the trouble of using two types of tags, therefore, the manufacture cost can be reduced and the entire outlook of the merchandise design will not be spoilt.

To achieve the previous mentioned objects, the present invention provides a tag reader, comprising an RF signal transmitter for generating an RF transmitting signal, wherein an RF reflecting signal will occur since the RF transmitting signal is shot at a tag; an RF signal receiver for receiving the RF reflecting signal; a micro processor connected to the RF signal transmitter and the RF signal receiver respectively, wherein the micro processor will generate a control signal in response to the RF reflecting signal transmitted from the RF signal receiver to the micro processor; a light source module connected to the micro processor for generating at least one scanning light source according to the control signal, wherein a barcode reflected signal will be generated after the scanning light source being shot at the tag; and an image sensor connected to the micro processor for receiving the barcode reflected signal, and transmitting the barcode reflected signal to the micro processor, wherein the micro processor will generate a tag comparing signal according to the barcode reflected signal.

To achieve the previous mentioned objects, the present invention provides a tag comprising a conductive barcode pattern layer, wherein the conductive barcode pattern layer comprises a plurality of vertical lines, any two adjacent vertical lines is connected by a horizontal line segment to form an RF antenna, wherein the vertical lines are compliance with RSS barcode specifications.

### BRIEF DESCRIPTION OF THE DRAWINGS

It will be understood that the figures are not to scale since the individual layers are too thin and the thickness differences of various layers too great to permit depiction to scale.

FIG. 1A is a diagram of the prior art regarding to the barcode reader is used to read the barcode.

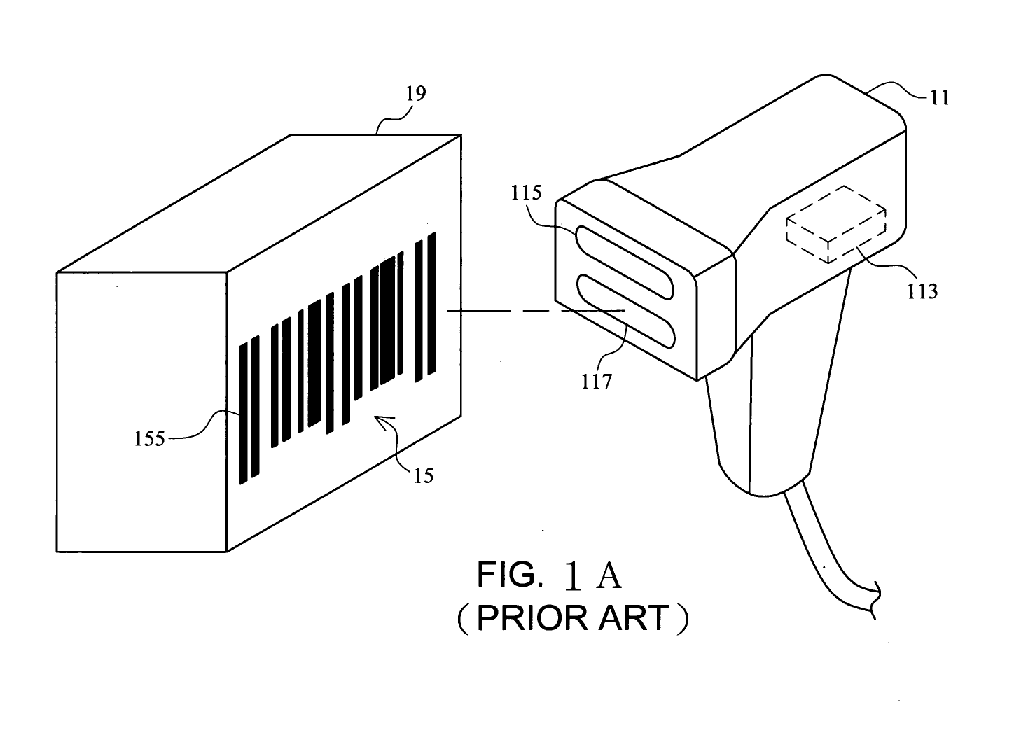

FIG. 1B is a diagram of the prior art regarding to the RFID reader is used to read the RFID tag.

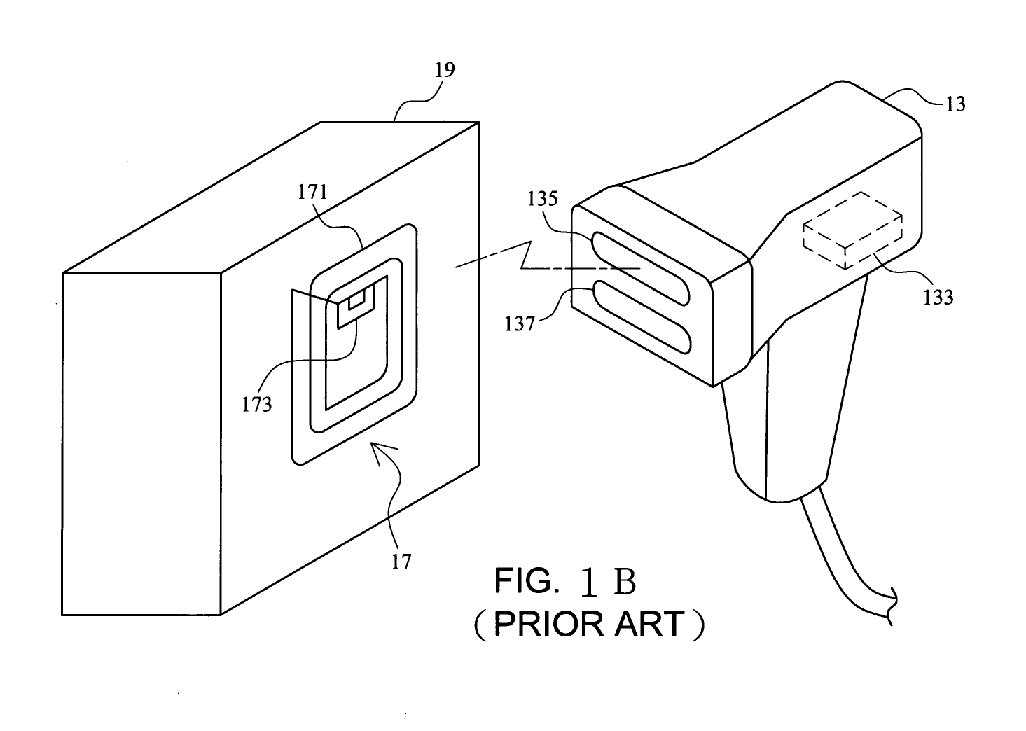

FIG. 2 is a diagram of a preferred embodiment of the present invention regarding to the tag reader is used to read the tag.

FIG. 3 is a structure diagram of a preferred embodiment of the present invention regarding to the tag reader.

FIG. 4 is a diagram of another preferred embodiment of the present invention.

FIG. 5 is a diagram of another preferred embodiment of the present invention.

### DETAILED DESCRIPTION OF THE INVENTION

The structural features and the effects to be achieved may further be understood and appreciated by reference to the presently preferred embodiments together with the detailed description.

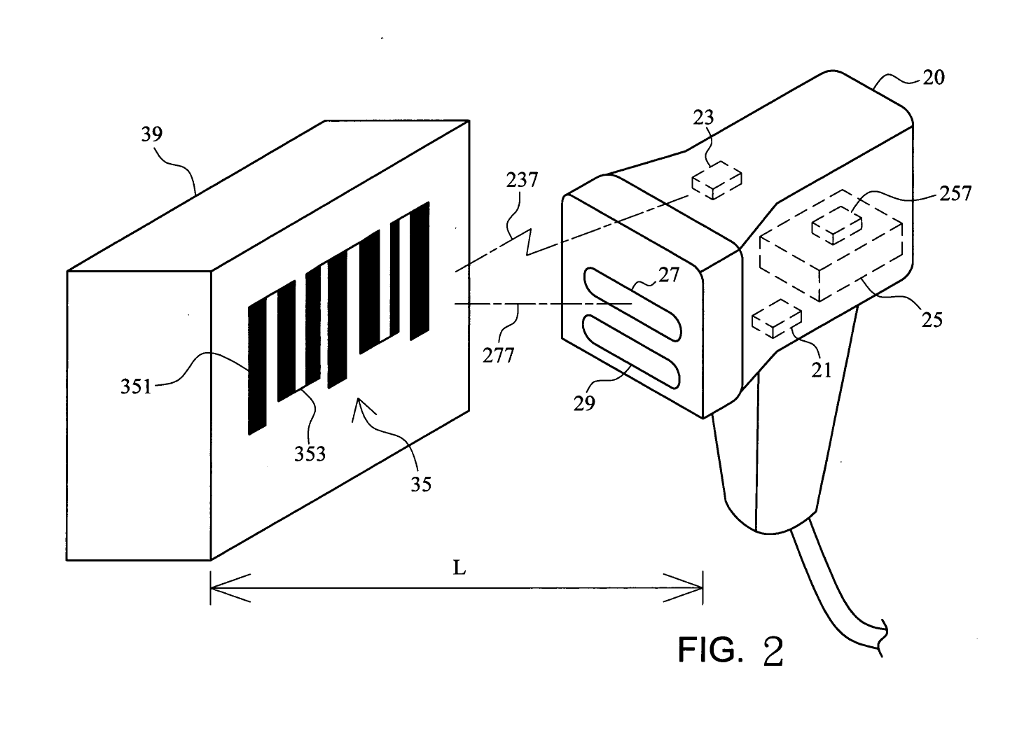

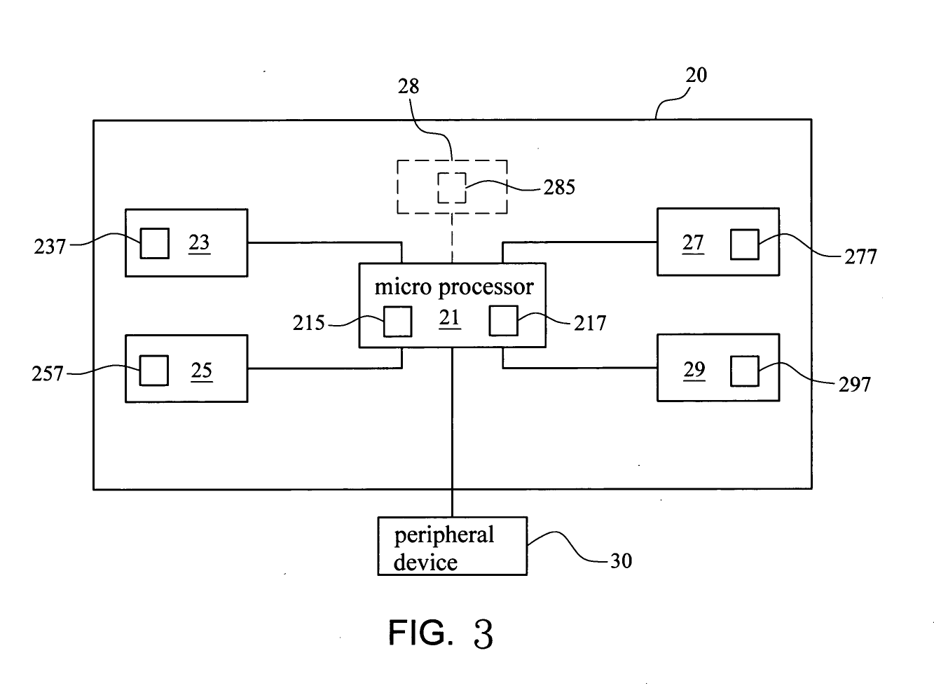

Referring to FIG. 2 and FIG. 3, a diagram of a preferred embodiment of the present invention regarding to the tag reader is used to read the tag and a structure diagram of a preferred embodiment of the present invention regarding to the tag reader are respectively disclosed. The tag 35 is a barcode pattern layer 35, which comprises a plurality of vertical lines 351 as well as the prior art optical barcode 15, wherein the vertical lines 351 are arranged to form a readable merchandise information, which are compliance with various specifications, such as the 1D barcode or the ENN.UCC, and convenient for a tag reader 20 to read by scanning with a scanning light 277.

All or parts of the vertical lines 351 are made of the conductive materials, such as the conductive pigment, or the metal material. The ends of parts of the conductive vertical lines 351 are connected to conductive horizontal line segments 353. The conductive vertical lines 351 which are connected to the conductive horizontal line segments 353 are further electrically connected to another vertical lines 351 through the horizontal line segment 353, such that an RF antenna can be formed due to the integration arrangement of the vertical lines 351 and the horizontal line segments 353.

The tag reader 20 comprises a micro processor 21 which is connected to an RF signal transmitter 23, an RF signal receiver 23, a light source module 27, and an image sensor 29. The RF transmitter 23 can generate and transmit an RF transmitting signal constantly, therefore, when a merchandise 29 is closing to the tag reader in an effective distance L, the RF transmitting signal 237 will be shot on the barcode pattern layer 35 placed on the merchandise 29, and further reflected to be an RF reflected signal 257.

The RF reflected signal 257 will be received by the RF receiver 25 within the effective distance L, and further, will be transmitted to the micro processor 21, such that the micro processor 21 will generate a control signal 217 accordingly, and the light source module will shoot a scanning light 277 in response to the control signal 217.

When the scanning light 277 is shooting on the barcode pattern layer 35, the scanning light 277 will be reflected to be a barcode reflected signal 297 according to the arrangement pattern of the vertical lines 351. And, the barcode reflected signal 297 will be received by the image sensor 29, and transmitted to the micro processor 21 for analyzing, thus, a tag comparing signal 215 will be generated, and the merchandise information according to the barcode pattern layer 35 will be obtained.

The tag comparing signal 215 can be also transmitted to a peripheral device 30, which is connected to the micro processor 21, for the merchandise information restoring; otherwise, the peripheral device 30 can be used for light alarming, sound alarming, data calculating, switch switching, and so on according to the tag comparing signal 215, wherein the peripheral device can be selectively one of an alarm bell, an alarm light, a merchandise database, a ID reader, a lock, a switch, or a network equipment.

The light source module 27 can be enabled due to the RF reflected signal 257 is received by the RF receiver 25 within the effective distance L, therefore, it is not necessary to shoot the scanning light 277 constantly. Thus the power consumption of the light source module 27 can be reduced, and the life-time thereof can be extended. The effective distance L is preferred to be less than 10 cm according to the preferred embodiment of the present invention, wherein the length of the effective distance L will be altered according to the environment variation.

Regarding to another preferred embodiment of the present invention, a timing controller 28 is used to set a period of time 285, such that the light source module 27 can be automatically disabled after the period of time 285, therefore, the optical scanning procedure for barcode pattern layer 35 have to be finished during the period of time 285, thus, the power consumption for the light source module 27 can be further reduced.

Furthermore, if the RF signal receiver has received the RF reflected signal from the tag 35 placed on the merchandise 39, and the tag 35 doesn't be scanned during the period of time 285, then the result will be showed that the merchandise 39 should be moved without authority. Accordingly, the peripheral device 30 will receive the alarm signal according to the tag comparing signal 215, and further inform people of problem checking, thus, the monitoring process is additionally enhanced.

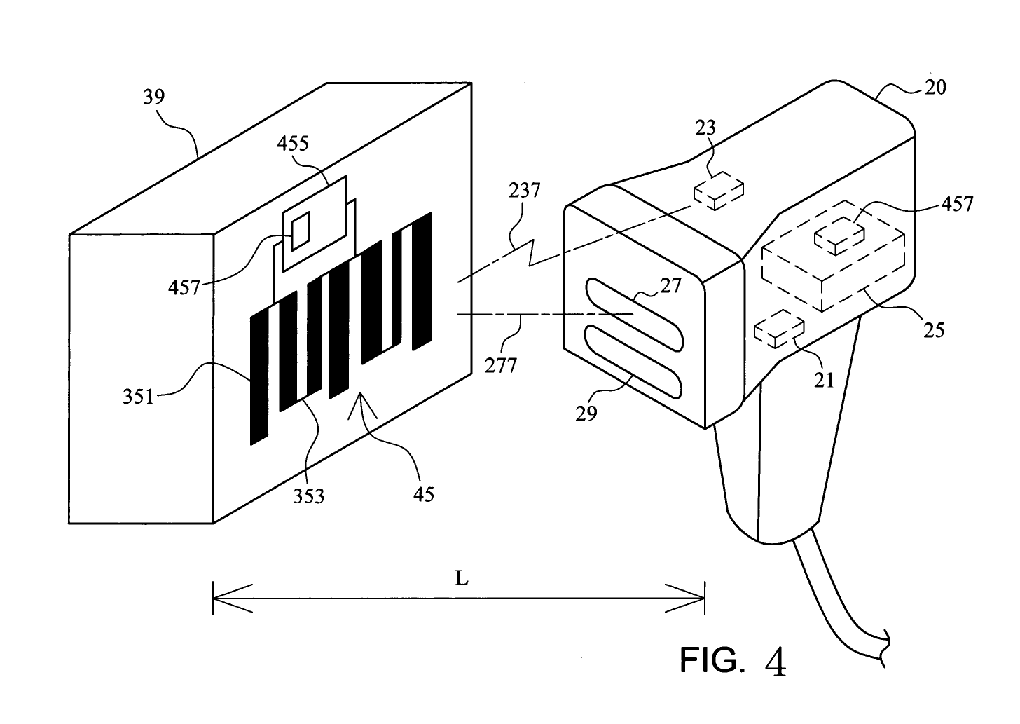

Referring to FIG. 4, a diagram of another preferred embodiment of the present invention is disclosed. The tag 45 further comprises an RF chip 455, wherein the RF chip comprises an RF chip data 457, which can record a great quantity of merchandise information and personal identification information. The RF chip 455 is electrically connected to the barcode pattern layer 35.

The RF chip data 457 is received by the RF signal receiver 25 following the RF reflected signal 257, and further, the RF chip data 457 will be transmitted to the micro processor 21 to compare with the barcode reflected signal 297 for double checking whether the read merchandise information is correct or not, such that the reliability of the merchandise information reading can be improved. The double check mechanism can also be used for personal identification or the entrance guard system.

Regarding to another preferred embodiment of the present invention, one end of the barcode pattern layer 35 is electrically connected to the first electrode of the RF chip 455, and parts of vertical lines which are not included in the RF antenna are electrically connected to the second electrode of the RF chip 455. The vertical lines connected to the second electrode are used as the grounding conductor for modulating the transmitting and receiving efficiency of the circuit. Such that the barcode pattern layer 35 forms an inverted-F antenna or a planar antenna.

Regarding to another preferred embodiment of the present invention, various types of the RF antennas can be formed due to the arrangement and connection of the vertical lines 351 and the horizontal line segments 353. By arranging the connection of the vertical lines and the horizontal line segments with the first electrode and second electrode of the RF chip 455, various types of antennas can be selectively formed, such as a dipole antenna, a loop antenna, and a helix loop antenna, for operating under different purposes and environments.

Since the barcode pattern layer 35 can be formed as the RF antenna, the area of tag 45 placed on the merchandise 39 can be reduced. Furthermore, the prior art tag reader can read only one type of tag, which is either the barcode or the RFID tag. The present invention can overcome this shortcoming regarding to the tag reader of the present invention can read both types of tags. Such that the shop can have only one tag reader for reading both types of tags, and the merchandise can be attached single tag, therefore, the cost for replacing the tag reader of the prior art can be reduced. Certainly, regarding to the foregoing embodiments, the vertical lines can be connected to form an RF antenna or an RF signal transmission path, however, which can be achieved by parts of the vertical lines, and the rest of the vertical lines can be further extended or connected to have better RF signal transmission path for suiting various logistics management operation circumstances.

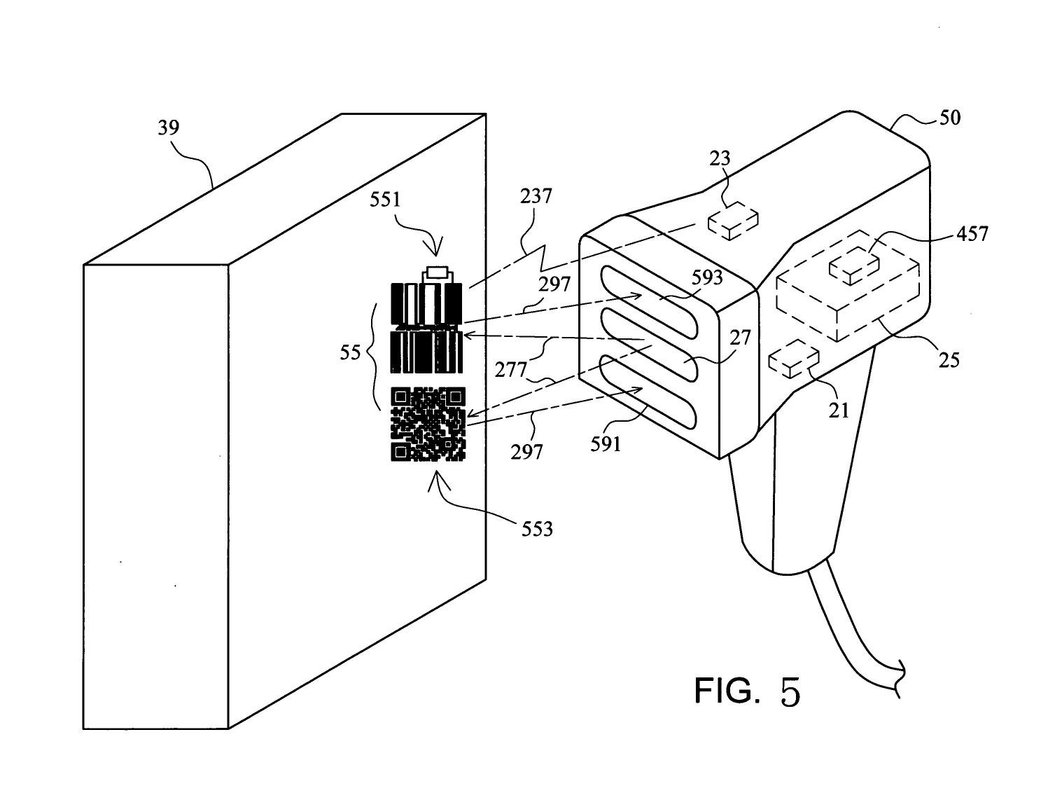

Referring to FIG. 5, a diagram of another preferred embodiment of the present invention is disclosed. The tag 55 comprises not only the barcode pattern layer 551 but also a 2D barcode 553, wherein the 2D barcode is also named a Quick-Response code. The tag reader 50 comprises a first image sensor 591 and a second image sensor 593. The light source module 27 can be used to shoot the scanning light 277 at the barcode pattern layer 551 and the 2D barcode 553 in the meantime. Then the barcode reflected signal 297 reflected by barcode pattern layer 551 will be received by the first image sensor 591, and the barcode reflected signal 297 reflected by the 2D barcode will be received by the second image sensor 593. Both of the reflected signals 297 will be transmitted to the micro processor 21 for cross comparing and double checking, such that the reliability of the merchandise information reading will be improved.

Regarding to another preferred embodiment of the present invention, the micro processor 21 can receive the RF chip information 457 from the RF chip 455. Therefore, the RF chip information 457, the information of the barcode pattern layer 551 and the 2D barcode 553 can be transmitted to the micro processor 21 for comparing, and that the function of triple check will be achieved.

The barcode pattern layer 551 can be formed not only the 1D barcode, the EAN.UCC, but also the Reduced Space Symbology barcode, as shown in FIG. 5.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

I claim:

1. A tag reader, comprising:
an RF signal transmitter for generating an RF transmitting signal, wherein an RF reflecting signal will occur since said RF transmitting signal is shot at a tag;
an RF signal receiver for receiving said RF reflecting signal;
a micro processor connected to said RF signal transmitter and said RF signal receiver respectively, wherein said micro processor will generate a control signal in response to said RF reflecting signal transmitted from said RF signal receiver to said micro processor;
a light source module connected to said micro processor for generating at least one scanning light source according to said control signal, wherein a barcode reflected signal will be generated after said scanning light source being shot at said tag; and
an image sensor connected to said micro processor for receiving said barcode reflected signal, and transmitting said barcode reflected signal to said micro processor, wherein said micro processor will generate a tag comparing signal according to said barcode reflected signal.

2. The tag reader of claim 1, further comprising a timing controller connected to said micro processor for generating a period of time, wherein said micro processor will determine whether generating said control signal, controlling said light source module to disable said scanning light source, or generating said tag comparing signal according to said period of time.

3. The tag reader of claim 1, further comprising a peripheral device connected to said micro processor for receiving said tag comparing signal.

4. The tag reader of claim 1, wherein said tag further comprises a RF chip, said RF chip comprises a RF chip data, and said RF chip data will be received by said RF signal received through said RF reflecting signal, further, said micro processor will generate said tag comparing signal according to said barcode reflected signal and said RF chip data.

5. The tag reader of claim 1, wherein said tag comprises a conductive barcode pattern layer, said conductive barcode pattern layer comprises a plurality of vertical lines, and two adjacent vertical lines are connected by a horizontal line segment to form an RF antenna.

6. The tag reader of claim 5, wherein said vertical lines of said conductive barcode pattern layer are formed selectively one of a 1D barcode or an RSS barcode.

7. The tag reader of claim 6, wherein said tag further comprises a 2D barcode positioned on the side of said conductive barcode pattern layer, said image sensor further comprises a first image sensor and a second image sensor, wherein said first image sensor is used to receive said barcode reflected signal reflected by said conductive barcode pattern layer, said second image sensor is used to receive said barcode reflected signal reflected by said 2D barcode.

8. The tag reader of claim 1, wherein there is an effective distance between said RF signal receiver and said tag, said effective distance is less than 10 cm.

9. The tag reader of claim 3, wherein said peripheral device is selectively one of an alarm bell, an alarm light source, a merchandise database, an ID reader, a lock, a switch, or a network equipment.

10. A tag comprising a conductive barcode pattern layer, wherein said conductive barcode pattern layer comprises a plurality of vertical lines, any two adjacent vertical lines is connected by a horizontal line segment to form an RF antenna, wherein said vertical lines are compliance with RSS barcode specifications.

11. The tag of claim 10, further comprising an RF chip connected to said conductive barcode pattern layer, wherein said RF chip comprises an RF chip data.

12. The tag of claim 10, further comprising a 2D barcode positioned on the side of said conductive barcode pattern layer.
